(19) United States
(12) Patent Application Publication
(10) Pub. No.: US 2005/0056117 A1
(43) Pub. Date: Mar. 17, 2005

(54) Composite strut and method of making same

(75) Inventor: Brian Jones, San Gabriel, CA (US)

Correspondence Address: ROBERT J. SCHAAP, Suite 188, 21241 Ventura Boulevard, Woodland Hills, CA, 91364, US

(73) Assignee: Kaiser Compositek, Inc.

(21) Appl. No.: 10/877,132

(22) Filed: Jun. 25, 2004

Related U.S. Application Data
(63) Continuation-in-part of application No. 10/650,441, filed on Aug. 27, 2003.
(60) Provisional application No. 60/489,538, filed on Jul. 22, 2003.

(51) Int. Cl. F16B 1/00

(52) U.S. Cl. 74/579 R

(57) ABSTRACT

A filament wound strut as well as a method of making the strut. The filament wound strut has a cylindrical section merging into ends through tapered end sections and which ends may be forked or otherwise arranged to receive a lug fitting. The flat ends are provided with a specially designed pre-form having a generally oval shape, and which is formed by filament reinforcement in a racetrack format surrounding a quasi-isotropic laminate. In accordance with this construction, the wound structure will react to tension loads and the inner laminate reacts to compression loads, while improving the load transfer through edge bearing and shear. A method of producing the strut is also provided in which filament materials are wound about a mandrel which is disassemblable and removable from the strut body formed thereon.

### RELATED APPLICATIONS

This application is a continuation-in-part of my co-pending U.S. Utility patent application Ser. No. 10/650,441, filed Aug. 27, 2003, for Filament Wound Strut and Method of Making same. This application is also based on and claims, for priority, the filing date of my U.S. Provisional Patent application Ser. No. 60/489,538, filed Jul. 22, 2003.

### BACKGROUND OF THE INVENTION

1. Field of the Invention

This invention relates in general to certain new and useful improvements in filament wound struts and, more particularly, to filament wound struts constructed in such manner that they are effective in reacting to tension loads as well as to compression loads and to facilitate transfer of such loads into the composite material through edge bearing and shear modes. This application also relates in general to unique methods of making filament wound struts in such manner that the mandrel used to form the strut can be removed from the strut which is formed.

2. Brief Description of Related Art

Struts are used to carry loads in a wide variety of equipment and in a variety of applications. Exemplary thereof is the use of strut based structures for reacting static or quasi-static loads in addition to allowing for movement of structures or a portion thereof. Mechanisms which use these struts are, e.g. aircraft and the like. Struts are also used in satellite and space-vehicle and space station applications. In applications of this type in which lifting of the vehicle or station necessitates overcoming the force of gravity, the strength and stiffness to weight ratio is an important design consideration. Struts made of composites can offer a weight savings of 40 to 60 percent over metal counterparts.

In most cases, struts are formed of structural metals, such as aluminum, titanium or steel, since they are typically designed to carry substantial loads. Exemplary of U.S. patents in which struts are used in aircraft are U.S. Pat. No. 5,366,181, dated Nov. 22, 1984 to Hansen and U.S. Pat. No. 4,821,983 to Aubry et al. The use of struts in other structures such as forks for two wheeled vehicles are shown, for example, in U.S. Pat. No. 5,609,349, dated Mar. 11, 1997, to Buckmiller et al. and in arches in U.S. Pat. No. 5,244,669, dated Jul. 6, 1993, to Guimbal.

The use of composite struts is also well known in the prior art and are identified, for example, in U.S. Pat. No. 4,740,100, dated Apr. 26, 1988, to Saarela et al. and in U.S. Pat. No. 4,336,868, dated Jun. 29, 1982, to Wilson et al. as well as U.S. Pat. No. 6,299,109 B1, dated Oct. 9, 2001, to Stephan et al. Composite struts could be efficiently used in some of those applications, mentioned above, where metal struts were employed.

Compression and tension loads are transmitted into a strut through bearing and shear modes. In such cases, a composite material may not be capable of reacting such loads efficiently, thereby potentially limiting the use of composite struts. The composite material is highly effective at reacting tension loads and compression loads, but they are limited, to some extent, by their inability to react bearing and shear modes of loading.

The design of any strut requires consideration of various instability modes, including stability in buckling and local crippling, fatigue resistance, both in tension and compression, impact resistance, etc. The design of the extremity of a strut is also an important consideration. One commonly used extremity is a forked end, effective for enabling connection to another member. This is important for struts which are designed to react substantial loads as, for example, 20,000 pounds and more.

Frequently, a number of struts are arranged and connected to a common fitting or node. In these cases, it may be necessary to taper the ends of the struts in order to accommodate all of the struts connected at this common node. Not only does the provision of a taper complicate the manufacturing process but, to some extent, unless the struts are constructed properly, it will also impair the strength characteristics of the struts. Moreover, the efficiency with which the end fittings are integrated into the strut design will have a significant influence on the final weight of the strut and, therefore, its overall structural efficiency.

There is a wealth of prior art which teaches of the method of making filament wound and other composite struts. However, none of this prior art has provided any effective means of efficiently transferring shear and bearing loading at the terminal end of the strut. This is particularly true where the strut may connect to another load transmitting member. Consequently and heretofore, there has not been any effective filament wound strut or any method of making same which is capable of transmitting high tension loads and compression loads through an eye or terminating element at an end of the strut. It would therefore be highly desirable to provide a strut, as well as a method of making same, which could efficiently transmit such loads through shear and bearing.

Cost considerations are also important in almost all applications. Inasmuch as many composite structures are typically made on some type of mandrel, it is necessary to use a fabrication method to produce a strut in which the mandrel does not remain a part of the final structure and thereby add parasitic weight.

### OBJECTS OF THE INVENTION

It is, therefore, one of the primary objects of the present invention to provide a composite strut which is highly effective in reacting both tension and compression loads and which also efficiently transfers both shear and bearing stresses into a terminating end element of the strut.

It is another object of the present invention to provide a composite strut of the type stated which can be used in a wide variety of applications including, but not limited to, for example, aircraft and like applications.

It is a salient object of the invention to provide a composite strut which minimizes the weight of the strut by assuming the advantage of a high stiffness to density and high strength to density ratio of materials which are used in the making of the strut, including but not limited to materials reinforced by filaments, such as carbon, graphite and boron.

It is another salient object of the invention to use a filament winding process for producing a composite strut in the form of a single piece structure and which includes fork-shaped end extremities and with inserts in the end extremities, allowing for transference of both tensile and compressive loads introduced into the strut extremities by these inserts, and where the inserts may be pre-formed and race-track shaped and which inserts are actually integrated into the composite strut.

It is a further object of the present invention to provide a composite strut of the type stated which can be constructed with a reduced thickness end section which integrates a pre-form to permit transfer of shear and bearing forces.

It is also an object of the present invention to provide a method of making a composite strut in such manner that a mandrel used as the form upon which the strut is fabricated can be removed from the strut after formation thereof allowing the mandrel to be repeatedly used.

It is an additional object of the present invention to provide a method of manufacturing a composite strut in which a mandrel is used to form the composite tubular sidewall and end-feature of the strut and which mandrel is formed in sections so that it can be effectively disassembled in the strut and removed through the ends of the strut body formed thereon.

It is an additional object of the present invention to provide a method of manufacture of a composite strut having the desired axial stiffness through largely axially (0 degrees-15 degrees to axis) oriented fibers and the required strength in the fork or lug sections thereof to readily transmit shear and bearing loading using a pre-formed insert in the form of a racetrack.

The present invention generally provides a strut which can be used in a wide variety of load transmitting applications, is formed of filamentary material and which is made in a relatively inexpensive process requiring minimal labor, such as is associated with filament winding.

With the above and other objects in view, my invention resides in the novel features of form, construction, arrangement and combination of parts and components presently described and pointed out in the claims.

### SUMMARY OF THE INVENTION

The present invention relates broadly to both a strut comprised primarily of specific composite materials and orientations capable of effectively reacting a variety of load conditions and to an improved method of making the strut.

For purposes of this invention, a strut largely refers to a structural element where the dominating design requirement involves the transmission of a compressive load and/or tension load. While composites have many attributes, including high stiffness in certain directions, for purposes of the invention, the strut must provide adequate stiffness and strength in other than the axial direction.

The composite strut of the invention is preferably, although not necessarily, made by filament winding techniques. Various other techniques, including hand lay-up, if desired, can be used to form the strut of the invention. The composite strut may preferably, although not necessarily, be a cylindrically shaped section with relatively flat ends tapering into the elongate section.

The strut may be comprised of a body, such as an elongate body, having a polygonal shape and, more particularly, a rectangular or square shape. However, the strut can be made with other cross-sectional shapes as well. The strut is also provided with flat ends which may preferably be in the nature of forked ends. The body tapers into the flat end or ends. However, the ends may have shapes other than relatively flat ends. Typically, connecting nodes are provided at these ends, whether the fork-shaped end is or is not used.

In a preferred embodiment, the strut may have relatively flat ends, as aforesaid. The taper of the body, such as a round elongate body of the strut, slowly merges into relatively flat ends which have relatively flat opposed end surfaces. In order to effectively react edge load and shear, the flat ends may be formed with a quasi-isotropic pre-form incorporated therein and with filament type reinforcement wound around the periphery thereof in a racetrack type arrangement. This construction is highly effective in that the winding will react to tension loads, and the inner laminate reacts to compression loads.

In order to provide the proper strength characteristics, the flat ends of the strut are provided with specially oriented pre-forms. Each of these pre-forms are made from a quasi-isotropic material with a peripheral reinforcing band, typically in the form of a laminate of quasi-isotropic material. Filament winding is thereafter used for winding filament reinforcement around the quasi-isotropic laminate. A center insert is located in this laminate and provides an end at which a load is transferred, typically through a pin inserted into a bushing, located in the pre-form. In accordance with this construction, this filament winding band largely reacts tension loads while the inner laminate reacts compression loads. This construction avoids the load being dominantly transferred into the composite material through edge bearing and shear.

The mandrel which is used to form the body of the strut, does not remain within the strut. Moreover, the strut which is produced can be considered as having an elongate tubular body with relatively flat opposite end portions. Inasmuch as it is necessary to strengthen the end portions, a unique design allowing for connection of another structural member to the strut is provided.

The strut body is usually formed on a mandrel. For this purpose, the mandrel is usually mounted on a shaft. The mandrel shaft may extend completely through or partially through the mandrel. In addition, the mandrel is preferably formed of a metal such as steel or aluminum with flat ends physically attached to the opposite ends of the mandrel. In the most preferred embodiment, at least one and preferably both of the flat ends form a forked end. The end portions on the mandrel transition into tapered sections which, in turn, become contiguous with and transition into the shaped body, e.g. cylindrically shaped body, of the mandrel. The strut body may be formed using any of a number of well known composite material fabrication techniques. With any of the techniques, as hereinafter described, the metallic end portions of the mandrel can be removed from the mandrel.

The mandrel which is used to form the strut body is a segmented mandrel provided with a plurality of separable sections. These individual sections are arranged to form the shape of the mandrel body and filament material is wound upon these segments. The various segments are mated with one another and, after formation of the mandrel, they can be pulled out of an open end of the strut body thus formed.

In either case, and when using a filament winding process, filament reinforcing material is wound about the entire mandrel in order to produce the strut body. Either wet or pre-impregnated filamentary material may be used in the winding process to produce the required axial and circumferential stiffness. Thereafter, the mandrel, with filamentary reinforcement wound thereon, can be consolidated and polymerized by a suitable process, such as autoclave, hydroclave or press molding.

There are several substantial advantages achieved with the strut of the invention, as well as with the method of making the strut. Initially, the use of the composite material minimizes weight by taking advantage of the high stiffness-to-density and strength-to-density ration of filament reinforced materials. Thus, filaments, such as carbon, graphite and boron are highly effective in providing the necessary ratios.

In addition, the use of filament winding to apply filament reinforced materials in the manufacture of the mandrel body or other component of the body allows for the use of the continuous winding process. This results in a one-piece structure including the fork-shaped extremities which effectively become integral with the structure. This mandrel structure with inserts is subsequently molded at autoclave temperatures and pressures to form a hardened structure, as mentioned above.

One of the important aspects of the invention is that tensile and compressive loads are introduced into the extremities of the strut, typically at the forked ends, by the actual integration of the race-track shaped composite inserts located in each of the forked elements. These inserts are precisely located in the extremities of the strut where a metallic bushing may be mounted during the winding process. When completely molded, the inserts become integrated into the composite structure.

The inserts are also unique in that they are formed of a centrally located quasi-isotropic material, such as a fabric material, around which continuous filament strands are wound. These elements are secondarily attached to the strut body and then integrally formed into the strut during the manufacture and, particularly, the filament winding thereof.

The method of producing the strut allows for transferring both tensile and compressive loads introduced into the extremities of the strut where failure may otherwise most likely occur. The invention eliminates these potential failure problems. Moreover, the use of the removable and reusable mandrel enables the strut to be produced in one piece. The end component which is usually the mounting component for the mandrel is preferably made in the form of a fork. However, it may also be in the form of a flat end having an eye.

It is recognized that if the terminal ends of the strut are actually integrated into the strut during production thereof, then a more efficient and cheaper product will be obtained. One of the problems solved by the present invention is a way to produce the strut in such manner to enable the terminal ends to be integral with the body of the strut.

Inasmuch as the terminal end portions of the strut must carry both tension and compression loads, orientation of the fibers at each of these terminal end portions then becomes an important factor. This is particularly true when filament winding is used in the production of the strut. However, a repeating and controlled winding pattern must be used and one which is also intrinsically stable.

This invention possesses many other advantages and has other purposes which may be made more clearly apparent from a consideration of the forms in which it may be embodied. These forms are shown in the drawings forming a part of and accompanying the present specification. They will now be described in detail for purposes of illustrating the general principles of the invention. However, it is to be understood that the following detailed description and the accompanying drawings are not to be taken in a limiting sense.

### BRIEF DESCRIPTION OF THE DRAWINGS

Having thus described the invention in general terms, reference will now be made to the accompanying drawings in which:

FIG. 1 is a perspective view of one form of strut, partially broken away, which may be constructed in accordance with and which embodies the present invention;

FIG. 2 is a fragmentary side elevational view of the strut of FIG. 1 and showing the profile thereof in side elevation;

FIG. 3 is an end fragmentary perspective view showing an end portion of the strut formed in accordance with the present invention;

FIG. 4 is a fragmentary top plan view, partially broken away, and showing a bushing mounted in the load transfer insert to receive a connecting element, e.g., a shaft, for connection to a structure to or from which a load is to be transferred;

FIG. 5 is an enlarged top plan view of a load transfer insert which can be used in the strut of a present invention;

FIG. 6 is a perspective view showing one of the major steps in the formation of the load transfer “racetrack” type insert of FIGS. 3-5;

FIG. 7 is a schematic view showing a filament winding process used in the formation of a racetrack type reinforcing band around the exterior of the load transfer insert;

FIG. 8 is a schematic perspective view showing a winding apparatus for winding about the quasi-isotropic load transfer insert of the present invention;

FIG. 9 is a fragmentary sectional view, taken substantially along line 9-9 of FIG. 8, and showing the winding of a peripheral band forming part of the insert used in the strut of the present invention;

FIG. 10 is a top plan view of a mandrel upon which the composite material is wound in accordance with the present invention;

FIG. 11 is a side elevational view of the mandrel with composite material wound thereon;

FIG. 12 is a top view of the multi-piece mandrel;

FIG. 13 is a fragmentary end perspective view, taken substantially along the plane of line 13-13 of FIG. 11, and showing the formation of the strut on the mandrel;

FIG. 14 is a sectional view taken along line 14-14 of FIG. 12;

FIG. 15 is a perspective view of the split mandrel used in the formation of the strut of the invention;

FIG. 16 is a sectional view taken along line 16-16 of FIG. 15;

FIG. 17 is a fragmentary side elevational view of a portion of the mandrel of FIGS. 15 and 16 and showing the positioning of mandrel segments forming a part thereof;

FIG. 18 is a fragmentary perspective view showing partial removal of center sections of the mandrel forming part of the present invention; and

FIG. 19 is a fragmentary perspective view similar to FIG. 18, and showing the complete removal of the center section of the mandrel with the beginning of removal of the remaining sections of the mandrel.

### DETAILED DESCRIPTION OF A PREFERRED EMBODIMENT

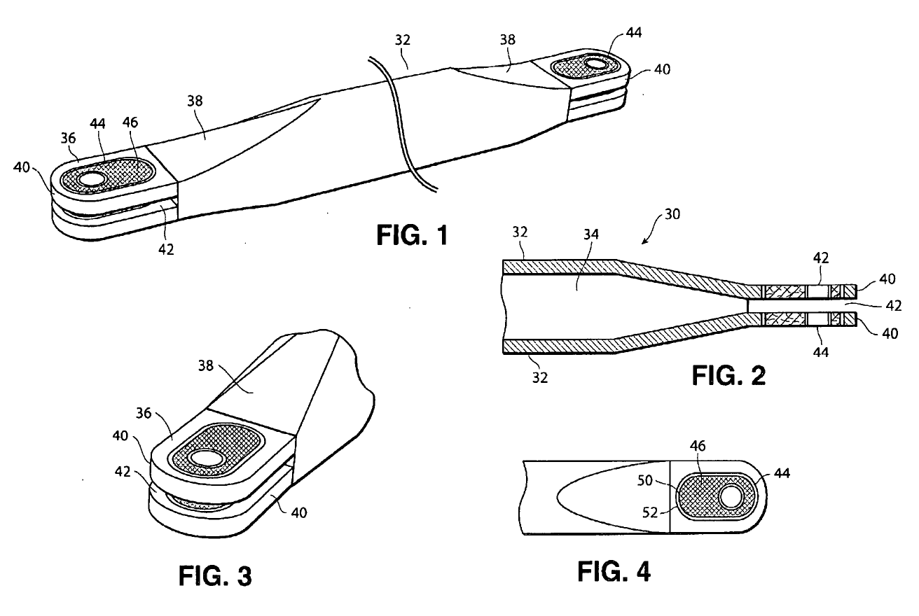

Referring now in more detail and by reference characters to the drawings, 30 designates one form of strut which may be constructed in accordance with the present invention and includes a cylindrically shaped body 32 as best shown in FIG. 1. In this particular embodiment, and as shown in FIG. 2, the body 32 is shown as being hollow having a central interior cavity 34.

The body 32 is primarily formed of composite material, e.g., filament wound carbon-epoxy, etc. Generally, the body can be fabricated of any reinforced composite material but is ideally formed using a conventional filament winding operation. Exemplary of the filament reinforcement are filaments of carbon, glass, boron and the like. Moreover, the filaments can be cured in either a thermosetting resin or a thermoplastic resin. A well known number of thermosetting and thermoplastic resins are available for this purpose.

The body 32 at one of its ends and, preferably, at both of its ends, tapers into the forked ends 36 through tapered regions 38. These forked terminal end sections 36 are usually comprised of a pair of end plates or so-called leaves 40 separated by a gap 42.

Each of the leaves or plates 40 forming the forked end 36 is provided with an opening 44, as best shown in FIG. 2 of the drawings. Thus, after the strut body is wound upon the mandrel, it is formed with a forked end as shown in FIGS. 1 and 2 and also the plates of that forked end will have central openings 44 for receipt of load transfer inserts 46. Each load transfer insert is designed to enable transference of loads into the strut. Each of the load transfer inserts 46 are mounted within the openings 44 after the basic strut body has been partially formed on the mandrel as hereinafter described. Each load transfer insert is effective for transferring tension and compression loads without the otherwise potentially damaging compression, edge-bearing and shear modes.

Each load transfer insert 46 is prepared prior to and independently of the strut body and is further comprised of a quasi-isotropic core 50 and a filament wound peripheral reinforcing strip 52. This assembly of the core 50 and peripheral reinforcing strip 52 is best shown in FIGS. 1, 4 and 5 of the drawings. This assembly is then overwound with additional reinforcement (not shown).

A separate load transfer insert is preferably positioned at each of the opposite ends of the strut and in each of the two sides of the fork. Inasmuch as each load transfer insert has been prepared prior to the actual inclusion of the insert during manufacture of the strut body, the load transfer insert is referred to as a “pre-form”.

The core 50 of the insert, is formed of a laminate of individual layers to form a quasi-isotropic material, as aforesaid. Any suitable laminatable material may be provided for this purpose. Preferably, the material forming the laminate layers is of fabric form.

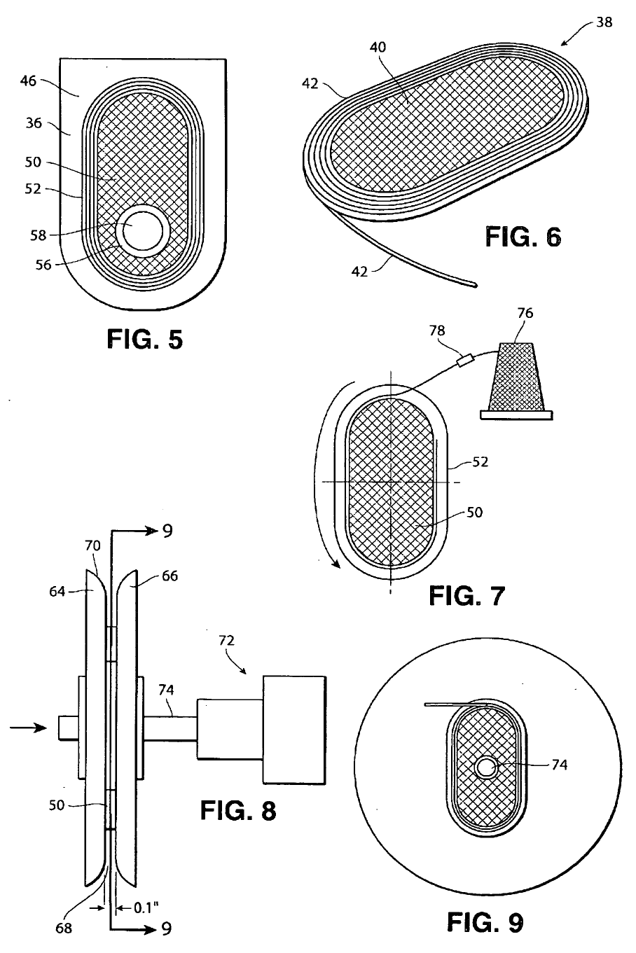

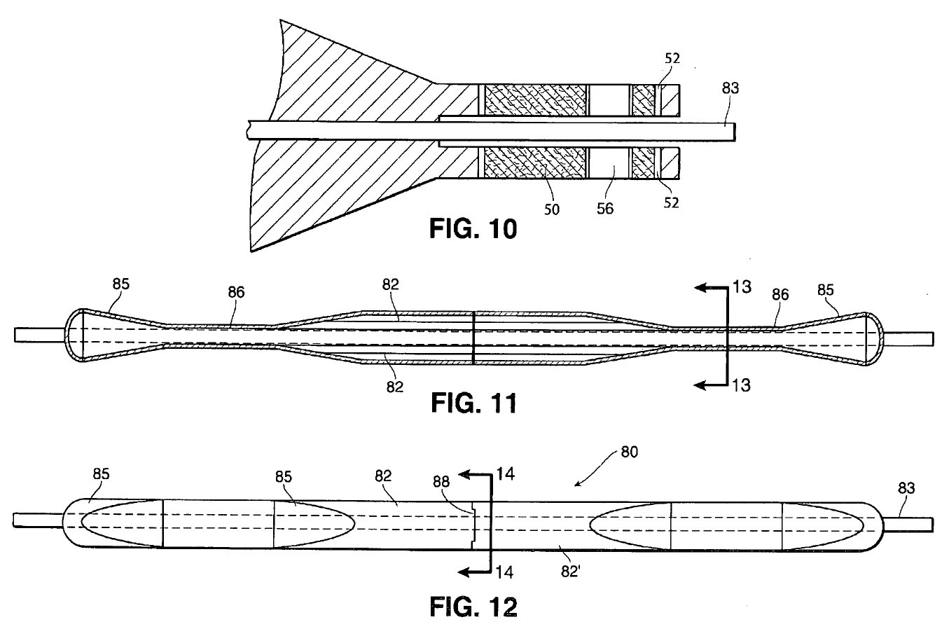

The core 50 is preferably elliptically shaped or oval shaped with opposite flat surfaces. One end of the load transfer insert and typically the outer end of the insert 40 essentially identifies an axis at which the load is transferred to the strut. For this purpose, one end of the insert 46 and, typically, the outermost end of the insert, is provided with a bushing 56. For purposes of transferring load, this bushing can be sized to receive a pin, such as a pin 58, as shown in FIG. 5. This pin would be used to connect to another structure for the transference of load.

Generally, the core 50 is a quasi-isotropic laminate, preferably formed of reinforcing fabric. The laminate will have an almost uniform strength in a generally planar direction to the surface thereof. The use of the load transfer insert 46 is effective in the strut of the invention since it takes into account the properties of composite materials in tension and compression. Moreover, it is particularly desirable for highly loaded struts.

The fiber lay-up pattern which results in the body of the strut is within 10 to 15 degrees relative to an elongate axis of the strut in the center portion of the strut. However, in the winding operation, because of the fact that the end portions are relatively flat and more narrow, the angle of the lay-up towards the extremities of the strut is now roughly about ±45 degrees. As a result, any force applied to the pin 58 allows transference of the load in the direction of the axis of the strut without creating severe edge bearing and shear loading.

In a compression mode, when a force is applied to the pin 58 the ±45 degree fabric effectively resists the compression loading. In order to obtain optimum strength in tension, the filamentary band 52 is wrapped about the core 50 in somewhat of a racetrack type form and this improves load transfers from an axial load in tension.

The process for producing the load transfer insert used in the strut of the invention is more fully illustrated in FIGS. 6-9 of the drawings. Initially, the core 50 of the insert is formed by laminating a plurality of layers of isotropic or quasi-isotropic material which may preferably be in the form of reinforcing fabric. Thereafter, after the basic core 50 has been formed, the band of reinforcing material 52 is wound about the core 50 to form the insert, all as best shown in FIG. 6 of the drawings.

In the winding process to produce the racetrack wound band 52, is but shown in FIGS. 7-9 of the drawings. The laminated core 50 of the load transfer insert 46 is captured between a pair of plates 64 and 66 and which form a very thin gap 68 therebetween. The plates 64 and 66 preferably have inwardly rounded inner peripheral edges 70. The core upon which winding occurs is rotated by a drive mechanism 72 connected to a drive shaft 74, as best shown in FIG. 8 of the drawings.

Filamentary material is wound in this gap 68 to form the reinforced plastic peripheral band 52. In this case, the reinforcement may be pre-impregnated or otherwise impregnated as it is wound and deposited in the gap 68. By continuously building up the reinforcement in that gap 68, the racetrack shaped peripheral band 52 of the desired cross-sectional thickness is achieved.

FIG. 7 also shows, in a very basic form, a winding apparatus which comprises a supply of reinforcing material as, for example, a spool of the material 76 with a strand feeding through the feed member 78. In this case, the core 50 is rotated and the reinforcing material is wound thereabout to form the peripheral band 52. For this purpose, the core can be mounted on the rotatable shaft 74.

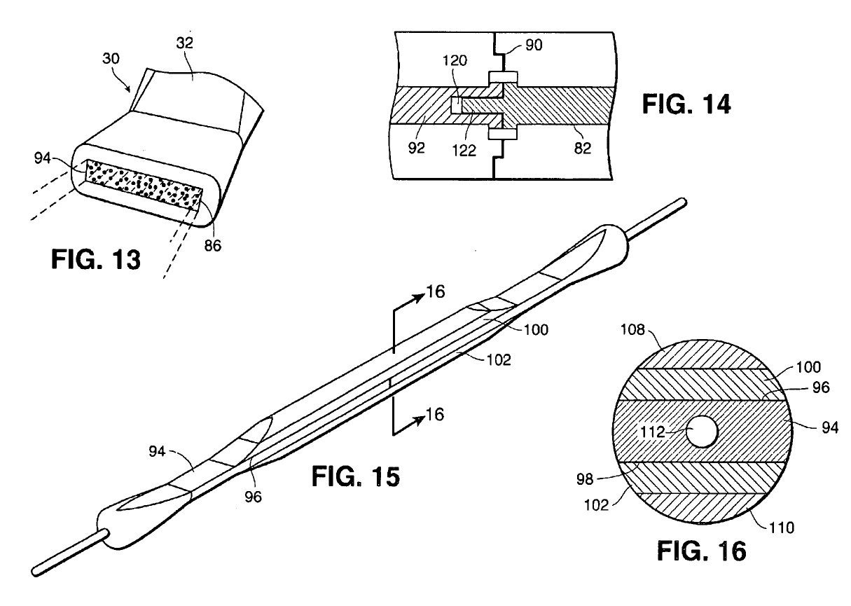

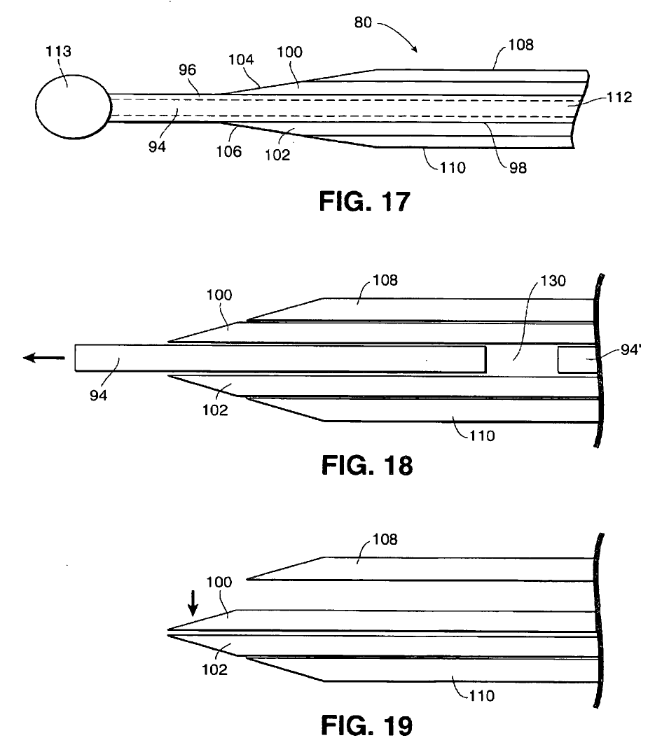

The strut body is formed by use of a mandrel 80 as best shown in FIGS. 11-19 of the drawings. The mandrel 80 is typically mounted on a mandrel shaft 83 and the latter of which is mounted in a winding apparatus (not shown) for causing rotation of the mandrel. In this way, filamentary material from a source thereof is wound upon the mandrel in the desired orientation.

By reference to FIGS. 11 and 12, it can be observed that the mandrel has an outer shape similar to the strut body to be formed. Thus, and in the embodiment as shown, the mandrel has a main mandrel body section 82 upon which the main body of the strut is formed and reduced tapered sections 84 which enable the formation of the tapered sections at outer portions of the body 38. End portions 85 of the mandrel are connected to the main mandrel body section of the mandrel and can be removed and discarded if desired. In addition, other end sections providing additional desired terminal end shapes on the strut can be used for this purpose. The mandrel may also be provided with connecting sections 86 allowing for connection of different end pieces.

In addition to the foregoing, the mandrel is also transversely split at its center between the two axially spaced apart ends of the mandrel, as best shown in FIGS. 11 and 12. Thus, there is provided a connecting arrangement 88 which is best shown in FIG. 14 of the drawings. For this purpose, the connecting arrangement 90 comprises a type of stepped engagement of two axially aligned, end to end mandrel sections 82 and 82′ as shown in FIG. 14. The mandrel shaft 82′ may be provided with a recess 120 to receive a pin 122 on the shaft 82.

The mandrel used in the present invention is unique in that it is a segmented mandrel comprised of mandrel segments, as best shown in FIGS. 15-18 of the drawings. Thus, the mandrel is comprised of an elongate central mandrel segment 94 which has relatively flat upper and lower surfaces 96 and 98, and the latter is best seen in FIG. 16 of the drawings. Adapted for facewise disposition on the upper and lower flat surfaces 96 and 98 are intermediate mandrel sections 100 and 102. Moreover, it can be observed that these mandrel segments 100 and 102 have tapered ends 104 and 106 respectively which merge into and aid in forming the tapered sections 38 on the body of the strut. The mandrel also includes outer mandrel segments 108 and 110. For this purpose, the mandrel segments 104 and 106 have relatively flat outwardly facing surfaces and the mandrel segments 108 and 110 similarly have relatively flat inwardly facing matching surfaces so that the five mandrel segments can be disposed in facewise engagement, all in the manner as best shown in FIGS. 15-17 of the drawings. These mandrel segments are not connected to one another, but rather are held together in facewise engagement by the filament strands wound thereabout.

After the strut body has been wound upon the mandrel 80 comprised of the various mandrel segments, the individual mandrel segments of the mandrel 80 can then be removed from the open outer ends of the strut body thus formed, in the manner as best shown in FIGS. 18 and 19 of the drawings. By reference to FIG. 18, it can be observed that the center mandrel segment 94 has been split from a remaining center mandrel segment 94′, as shown in FIG. 18, leaving a gap 130. Thus, and in this way, one center mandrel segment 94 is pulled outwardly of one open end of the mandrel body and the other center mandrel segment 94′ is pulled outwardly from the opposite open end of the mandrel body. Again, only one center mandrel segment would be used if the strut to be formed were of a length no longer than that center mandrel segment. The length of the central mandrel segment must be somewhat limited since a longer mandrel segment will create increased frictional force and impede the attempt to remove the mandrel segment.

In any event, after the center mandrel segments 94 and 94′ have been removed, the remaining mandrel segments 100, 102 and 110 will then be allowed to drop in the cavity forming the strut body. At this point, these remaining mandrel segments can then be easily removed from the strut body.

In accordance with this method of making the strut, the weight of the mandrel is not added to that of the strut and, moreover, the mandrel can be reused. In addition, because the mandrel can be constructed in axially aligned sections, the length of the mandrel can be adjusted to accommodate the desired length of the strut. Thus, the overall cost of producing the strut is reduced.

Thus, there has been illustrated and described a unique and novel composite strut and method of making same and which thereby fulfills all of the objects and advantages which have been sought. It should be understood that many changes, modifications, variations and other uses and applications which will become apparent to those skilled in the art after considering the specification and the accompanying drawings. Therefore, any and all such changes, modifications, variations and other uses and applications which do not depart from the spirit and scope of the invention are deemed to be covered by the invention.

1. A load bearing strut formed primarily of a reinforced plastic composite and reacting tension and compression loading as well as minimizing effects of edge bearing and shear loading, said strut comprising:
a) an elongate section comprised of a reinforced composite material;
b) at least one terminal end section on an end of said elongate section; and
c) a load transfer insert in said end section formed of a quasi-isotropic material surrounded by a fiber reinforcing strip and having a portion therein for conducting load transference, such that the laminate reacts compression loads and the fiber reinforcing strip reacts tension loads reducing the prospect of failure by edge bearing and shear.

2. The load bearing strut of claim 1 further characterized in that said end section has a shape different than that of said elongate section and having portions which merge into a shape of the elongate section so that the two sections become effectively contiguous.

3. The load bearing strut of claim 1 further characterized in that said elongate section has a cylindrically shaped portion for a substantial portion of its length and that said terminal end section is a toric section.

4. The load bearing strut of claim 3 further characterized in that said end section has a pair of oppositely disposed surfaces and a portion which merges into a cylindrically shaped elongate section.

5. The load bearing strut of claim 1 further characterized in that said load transfer insert has a somewhat oval shape with a pair of opposite flat surfaces and that the portion therein for conducting load transference is located closer to one end of said oval-shaped portion.

6. The load bearing strut of claim 1 further characterized in that said strut is covered by an outer layer of fiber reinforcing material such that the elongate section and the end section are covered by the fiber reinforcing material wound thereabout.

7. A load bearing strut formed primarily of a reinforced plastic composite material and capable of reacting tension and compression loads while minimizing the effects of edge bearing and shear loading, said strut comprising:
a) an elongate section having a rounded portion thereon and being comprised of at least a reinforced composite material;
b) at least one terminal end section on said elongate section and having a portion which merges into the rounded shape of said elongate section and also a relatively flat plate-like section thereon and which plate-like section has flat opposed surfaces; and
c) a load transfer insert in said terminal end section and having an insert core section surrounded by fiber reinforcing material, said load transfer insert also having a portion therein adjacent one end portion thereof for conducting load transference, such that the laminate reacts compression loads and the fiber reinforcing strip reacts tension loads while reducing loads which would result in edge bearing and shear.

8. The load bearing strut of claim 7 further characterized in that said end section has a shape different than that of said elongate section and having portions which merge into a shape of the elongate section so that the two sections become effectively contiguous.

9. The load bearing strut of claim 1 further characterized in that said opposite faces of said end portion are formed of an insert core material and said end section is provided with a peripheral band of reinforcing material wound thereon.

10. The load bearing strut of claim 7 further characterized in that the entire strut is wound with filament reinforcing material.

11. A process for producing a load bearing strut capable of reacting to tension and compression loads while minimizing shear and edge bearing loads, said process comprising:
a) wrapping a peripheral edge of a preformed member with a filamentary reinforcing material to produce a load transfer insert;
b) locating a load transfer point in an end of an elongate member and with the elongate member and load transfer insert having the overall shape of the strut to be produced;
c) inserting the load transfer insert in proximity to one end of said elongate member; and
d) wrapping filament reinforcing material about said elongate member and said end of the elongate member having the load transfer insert therein to provide a load bearing strut.

12. The process for producing the load bearing strut of claim 11 further characterized in that the insert is somewhat oval shaped and the process comprises wrapping the filament in a somewhat oval pattern.

13. The process for producing the load bearing strut of claim 12 further characterized in that said insert is formed of a quasi-isostropic material.

14. The process for producing a load bearing strut of claim 12 further characterized in that said process comprises inserting said load transfer insert into an end plate secured to an elongate member, and winding filament reinforcing material about said end plate and said elongate portion.

15. A process for forming a composite body on a mandrel in such manner that the mandrel can be removed from the body without any destructive effect on the body, said method comprising:
a) providing components necessary to render a removable mandrel;
b) arranging such components to constitute a mandrel having a shape and size approximating that of the composite body to be formed;
c) applying a resin impregnated composite material to said mandrel and allowing for curing of the resin to provide a hardened composite body; and
d) physically causing removal of said mandrel from said body as formed without any destructive effect on the body.

16. The process for forming a composite body of claim 15 further characterized in that said body is a strut body having an elongate center section and a pair of end sections thereon.

17. The process for forming a composite body of claim 15 wherein said process further comprises:
a) the step of providing components to render a removable mandrel comprises providing a plurality of rigid component parts which are assemblable to render that removable mandrel; and
b) the step of physically causing removal of said mandrel further comprises effectively disassembling the rigid component parts by pulling one of the component parts out of the composite body and thereafter pulling any remaining component parts out of the body of the mandrel.

18. The process for forming a composite body of claim 17 further characterized in that said process further comprises:
a) using at least three component parts forming part of said mandrel and which are stacked together in an arrangement to have a shape similar to the composite body to be formed; and
b) the step of physically causing removal of said mandrel from said body comprises pulling a center component part out of an end of the composite body thus formed, allowing for collapsing of the remaining two component parts and thereafter pulling the remaining two component parts out of an end of the composite body.

19. An assembly for forming a mandrel upon which a composite body having an elongate body section and end section on said elongate body, said assembly comprising:
a) a first mandrel component;
b) a second mandrel component assemblable with said first mandrel component to form a mandrel upon which resin impregnated composite material can be applied;
c) said first and second mandrel components being formed of a material upon which a curing of the resin can take place; and
d) at least said first mandrel component having a transverse end capable of being physically engaged and pulled out of the composite body as formed.

20. The assembly for forming the mandrel of claim 19 further characterized in that said assembly comprises:
a) a third mandrel component assemblable with said first and second mandrel components to form a mandrel upon which the resin impregnated composite material can be applied; and
b) said first mandrel component being located intermediate said second and third mandrel components.

21. The assembly for forming the mandrel of claim 20 further characterized in that said assembly comprises end sections which are attachable to the arrangement of mandrel components as arranged to form the mandrel so that the composite body which is formed will have end sections thereon and where the end plates forming part of the mandrel can thereafter be removed.

22. The assembly for forming the mandrel of claim 20 further characterized in that said composite body is formed on said mandrel by filament winding a resin impregnatable filament strand upon said body.

23. The assembly for forming the mandrel of claim 22 further characterized in that said mandrel components are arranged so that the composite body thus formed thereon will have at least one open end thereon.
